(19) United States
(12) Patent Application Publication
(10) Pub. No.: US 2024/0113752 A1
(43) Pub. Date: Apr. 4, 2024

(54) PRECODED TRANSMISSION OF DATA

(71) Applicant: Telefonaktiebolaget LM Ericsson (pobl), Stockholm (SE)

(72) Inventors: Petter ERSBO, Knivsta (SE); Karl WERNER, SEGELTORP (SE); David ASTELY, BROMMA (SE); Jeong Hun KIM, KANATA (CA); Zhao WANG, TÄBY (SE)

(73) Assignee: Telefonaktiebolaget LM Ericsson (pobl), Stockholm (SE)

(21) Appl. No.: 18/267,406

(22) PCT Filed: Dec. 15, 2020
(86) PCT No.: PCT/SE2020/051216

§ 371 Date: Jun. 14, 2023

(51) Int. Cl. H04B 7/0456; H04B 7/06

(52) U.S. Cl. CPC H04B 7/0456; H04B 7/0626

(57) ABSTRACT

There is provided mechanisms for precoded transmission of data. A method is performed by a network node. The method comprises obtaining an indication that a CSI report as received from a user equipment served by the network node is of a quality below a quality threshold. The method comprises, in response thereto, transmitting, whilst applying at least one precoder, data towards the user equipment. The at least one precoder is a function of at least one CSI value reported from the user equipment earlier than the CSI report with quality being below the quality threshold was received.

### TECHNICAL FIELD

Embodiments presented herein relate to a method, a network node, a computer program, and a computer program product for precoded transmission of data.

### BACKGROUND

In communications networks, there may be a challenge to obtain good performance and capacity for a given communications protocol, its parameters and the physical environment in which the communications network is deployed.

For example, channel state information (CSI) might be needed to enable efficient data transmission for downlink (i.e., from the network node at the network-end to the user equipment at the user-end). CSI might be obtained by the network node by transmitting downlink reference signals, such as channel state information reference signal (CSI-RS) or synchronization signal blocks (SSBs) towards the user equipment, or by receiving uplink reference signals, such as sounding reference signal (SRS), from the user equipment. The downlink reference signals are thus transmitted from the network node towards the user equipment, and the user equipment then, upon having performed measurements on the downlink reference signals, reports the measurement back to the network node. The uplink reference signals are sent from the user equipment towards the network node, and hence reporting of measurements from the user equipment is not needed.

CSI can by the network node be obtained either periodically, e.g. by sending a downlink reference signal, or burst of downlink reference signals, every 20 ms and having the user equipment report measurements, or only when needed, e.g. by sending a downlink reference signal, or burst of downlink reference signals, when there is downlink data awaiting transmission.

To enable beamforming, the CSI reported by the user equipment might comprise a precoder matrix indicator (PMI) field, which indicate to the network node which precoder in a codebook (e.g. a 3GPP release 15 type-1 single panel codebook) is preferred by the user equipment. Depending on the size of the report in which the CSI is reported, the report might comprise a cyclic redundancy check (CRC) field, enabling error detection of the report.

At low channel quality, such as low signal to noise ratio (SNR), there is a risk that the user equipment reports an incorrect PMI due to low SNR of a received downlink reference signal. The network node might also fail to correctly decode uplink control information (UCI) carrying the PMI due to low SNR of the physical uplink shared channel (PUSCH) or physical uplink control channel (PUCCH) which in turn carry the UCI. Another issue is that due to movement of the user equipment, the radio propagation channel properties might change between the time the user equipment determined the PMI and the time that the network node uses the PMI for downlink transmission of data towards the user equipment. This means that, effectively, the incorrect PMI causes the beamformed downlink transmission of data to point in the wrong direction.

In this respect, PMI might be obtained and/or reported at large time intervals (such as in the order of tens of ms), so reporting an incorrect PMI, or failing to decode a reported PMI correctly, or using an outdated PMI, might lead to a large number of failed downlink transmissions of the data as the used beamform will point in the wrong direction, at least until a correct PMI is next reported.

If all retransmissions at protocol layer 1 (L1) fail, which might occur if an incorrect precoder is used for an extended amount of time, retransmission is triggered at a higher protocol layer. This is significantly more expensive resource-wise than retransmissions at L1. Further, the coverage limit for the physical downlink shared channel (PDSCH) may be defined as the SNR where the residual block error rate (BLER) cannot be kept below 1%. Residual BLER corresponds to how often higher retransmissions at higher protocol layers than L1 are needed.

Hence, there is a need for improved selection of precoders for precoded transmission of data in scenarios where there is a risk that the CSI reports are incorrect.

### SUMMARY

An object of embodiments herein is to provide selection of precoders for precoded transmission of data so that the issues noted above in scenarios where there is a risk that the CSI reports are incorrect are avoided, or at least mitigated or reduced.

According to a first aspect there is presented a network node for precoded transmission of data. The network node comprises processing circuitry. The processing circuitry is configured to cause the network node to obtain an indication that a CSI report as received from a user equipment served by the network node is of a quality below a quality threshold. The processing circuitry is configured to cause the network node to, in response thereto, transmit, whilst applying at least one precoder, data towards the user equipment. The at least one precoder is a function of at least one CSI value reported from the user equipment earlier than the CSI report with quality being below the quality threshold was received.

According to a second aspect there is presented a method for precoded transmission of data. The method is performed by a network node. The method comprises obtaining an indication that a CSI report as received from a user equipment served by the network node is of a quality below a quality threshold. The method comprises, in response thereto, transmitting, whilst applying at least one precoder, data towards the user equipment. The at least one precoder is a function of at least one CSI value reported from the user equipment earlier than the CSI report with quality being below the quality threshold was received.

According to a third aspect there is presented a network node for precoded transmission of data. The network node comprises an obtain module configured to obtain an indication that a CSI report as received from a user equipment served by the network node is of a quality below a quality threshold. The network node comprises a transmit module configured to, in response thereto, transmit, whilst applying at least one precoder, data towards the user equipment. The at least one precoder is a function of at least one CSI value reported from the user equipment earlier than the CSI report with quality being below the quality threshold was received.

According to a fourth aspect there is presented a computer program for precoded transmission of data, the computer program comprising computer program code which, when run on a network node, causes the network node to perform a method according to the second aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable selection of precoders for precoded transmission of data whilst avoiding issues noted above in scenarios where there is a risk that the CSI reports are incorrect.

Advantageously, by the at least one precoder being a function of at least one CSI value reported from the user equipment earlier than the CSI report with quality below the quality threshold was received, issues with using a precoder based on an incorrect CSI value for an extended time are avoided.

Advantageously, these aspects are applicable in scenarios where the user equipment is experiencing poor coverage or is moving at a high speed.

Advantageously, these aspects enable different precoders to be used for different retransmissions of data, thereby reducing the risk that all transmissions of the same data fail.

Advantageously, these aspects yield higher network performance than when cycling through random precoders or all possible precoders.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise.

The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 schematically illustrates precoder cycling according to an embodiment;

FIG. 3 schematically is a block diagram of a network node according to an embodiment;

FIG. 4 is a flowchart of methods according to embodiments;

FIGS. 5 and 6 show simulation results according to embodiments;

FIG. 7 is a schematic diagram showing functional units of a network node according to an embodiment;

FIG. 8 is a schematic diagram showing functional modules of a network node according to an embodiment;

FIG. 9 shows one example of a computer program product comprising computer readable storage medium according to an embodiment;

FIG. 10 is a schematic diagram illustrating a telecommunication network connected via an intermediate network to a host computer in accordance with some embodiments; and

FIG. 11 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

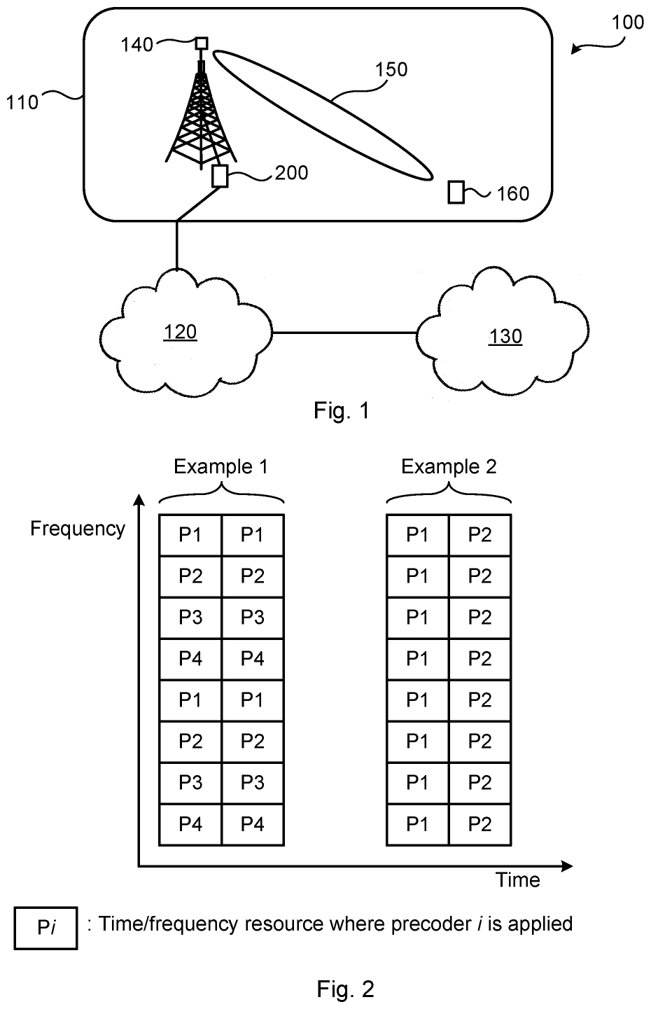

FIG. 1 is a schematic diagram illustrating a communication network 100 where embodiments presented herein can be applied. The communication network 100 could be a third generation (3G) telecommunications network, a fourth generation (4G) telecommunications network, a fifth generation (5G) telecommunications network, or any evolvement thereof, and support any 3GPP telecommunications standard, where applicable.

The communication network 100 comprises a network node 200 configured to provide network access to user equipment, as represented by user equipment 160, in a radio access network 110. The radio access network 110 is operatively connected to a core network 120. The core network 120 is in turn operatively connected to a service network 130, such as the Internet. The user equipment 160 us thereby enabled to, via the network node 200, access services of, and exchange data with, the service network 130. Examples of network nodes 200 are radio access network nodes, radio base stations, base transceiver stations, Node Bs, evolved Node Bs, gNBs, access points, access nodes, and backhaul nodes. Examples of user equipment 160 are wireless devices, mobile stations, mobile phones, handsets, wireless local loop phones, smartphones, laptop computers, tablet computers, network equipped sensors, network equipped vehicles, and so-called Internet of Things devices.

The network node 200 comprises, is collocated with, is integrated with, or is in operational communications with, a transmission and reception point (TRP) 140. The network node 200 (via its TRP 140) and the user equipment 160 are configured to communicate with each other in directional beams, one of which is illustrated at reference numeral 150. Which beamform the directional beam that is used by the network node 200 for transmission of data towards the user equipment 160 has depends on which precoder is applied by the network node 200. As noted above there is still a need for improved selection of precoders for precoded transmission of data in scenarios where there is a risk that the CSI reports are incorrect.

One way to mitigate this is to utilize precoder cycling. This implies that two or more precoders are cyclically applied at the network node 200 during downlink transmission of data towards the user equipment 160. One example of precoder cycling is illustrated in FIG. 2. In FIG. 2, P1, P2, P3, P4 denote differently used precoders in a time/frequency grid. That is, Pi for i={1, 2, 3, 4} indicates that precoder i is applied for the transmission of data in a certain time/frequency resource. FIG. 2 illustrates an example where the precoder cycling is performed over a random or a predetermined set of precoders. According to Example 1, the precoders may be frequency-wise cycled such that each precoder is used for a block of one or more physical resource blocks (PRBs). According to Example 2, the precoders can also be time-wise cycled, where each precoder is used for one or more slots. More specifically, to achieve diversity, the precoders are selected independently of the radio propagation channel. This is applicable when the network node does not have access to information about the radio propagation channel and where it therefore is desirable to space-wise spread the transmission of data. However, according to the herein disclosed embodiments, network performance might be improved if consideration also is made with respect to which precoders the network node 200 has previously applied for precoded transmission of data towards the user equipment 160, or other precoders that are available to, obtained by, or derivable by, the network node 200.

The embodiments disclosed herein therefore relate to mechanisms for precoded transmission of data. In order to obtain such mechanisms there is provided a network node 200, a method performed by the network node 200, a computer program product comprising code, for example in the form of a computer program, that when run on a network node 200, causes the network node 200 to perform the method.

At least some of the herein disclosed embodiments are based on the realization that even if the feedback from the user equipment to the network node is not perfect in the sense that some reports are received erroneously and/or become outdated due to movement of the user equipment, this does not mean that all the information, such as CSI values, of the CSI reports is useless. The reported information might still have some value, but just considering the last received CSI report, which might be erroneous, may not be sufficient and even impair the overall network performance.

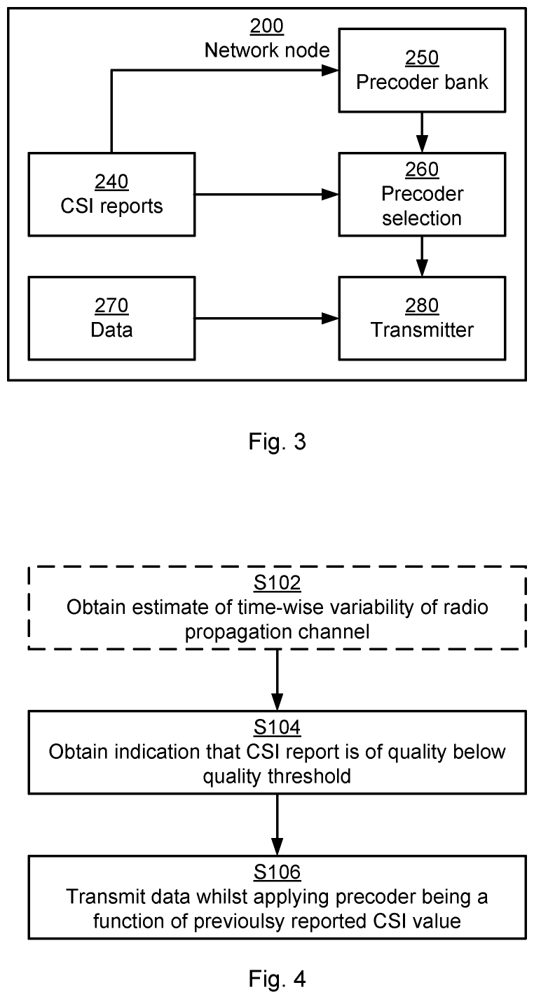

FIG. 3 is a block diagram of a network node 200 according to an embodiment. In FIG. 3 are shown functional blocks 240, 25, 260, 270, 280 relevant for precoded transmission of data. When a CSI report is received at the CSI reports block 240, the CSI values of the report is sent to the precoder selection block 260 and a precoder corresponding to the CSI value is stored in the precoder bank 250. The precoder selection block 260 then decides to either use a precoder corresponding to the reported CSI value or a previously used, or reported, precoder from the precoder bank 250, where the selection is based on information about the quality and reliability of the current and previous CSI reports. The selected precoder is then applied during transmission, at the transmitter block 280 of data from the data block 270.

FIG. 4 is a flowchart illustrating embodiments of methods for precoded transmission of data. The methods are performed by the network node 200. The methods are advantageously provided as computer programs 920.

Selection of at least one precoder used for the precoded transmission of data is based on the quality of the reported CSI. Therefore, the network node 200 is configured to perform step S104:

S104: The network node 200 obtains an indication that a CSI report as received from a user equipment 160 served by the network node 200 is of a quality below a quality threshold.

Examples of how the network node 200 might acquire CSI reports, and hence CSI values, as given above apply also to the herein disclosed embodiments. When a CSI report is received, the network node 200 checks the quality of the CSI value. If the CSI report is of poor quality, the network node 200 selects one or several precoders (depending on the cycling employed (based on an earlier reported CSI value), instead of the currently reported CSI value). In particular, the network node 200 is configured to perform step S106:

S106: The network node 200, in response thereto (i.e., in repose to having obtained the indication in step S104), transmits, whilst applying at least one precoder, data towards the user equipment 160. The at least one precoder is a function of at least one CSI value reported from the user equipment 160 earlier than the CSI report with quality being below the quality threshold was received.

If, on the other hand, the CSI report is of good quality, it is unlikely that the CSI value is incorrect and hence the at least one precoder is then based on the reported CSI value.

Embodiments relating to further details of precoded transmission of data as performed by the network node 200 will now be disclosed.

There could be different examples of CSI values. In some aspects, the CSI value is a PMI.

There may be different ways in which the at least one precoder could be a function of the at least one CSI value reported from the user equipment 160 earlier than the CSI report with quality being below the quality threshold was received. Different embodiments relating thereto will now be described in turn.

In some aspects, two or more precoders from a precoder bank are cycled through. In particular, in some embodiments, at least two precoders from a precoder bank are cyclically applied whilst transmitting the data towards the user equipment 160. Each of the at least two precoders is then a function of the at least one CSI value reported from the user equipment 160 earlier than the CSI report with quality below the quality threshold was received. As a non-limiting example, the network node 200 might be configured to cycle through the last x≥2 precoders indicated by historic CSI reports when it receives a poor quality CSI report.

In some aspects, the last x unique precoders indicated by historic CSI reports are cycled through. That is, in some embodiments, the network node 200 has obtained a sequence of CSI values reported from the user equipment 160 earlier than the CSI report with quality below the quality threshold was received. The precoder bank might then be composed of previously applied precoders that correspond to the CSI values as most recently reported in the sequence of reported CSI values.

In some aspects, the last x unique precoders indicated by historic CSI reports are cycled through, whilst accounting for the relative frequency of the precoders. That is, in some embodiments, how many occurrences of each precoder to include in each cycle according to which the at least two precoders from the precoder bank are cyclically applied is a function of frequency of occurrence of the CSI values in the sequence of CSI values.

In some aspects, the x most often used precoders indicated by historic CSI reports during some time t before the data transmission are cycled through. That is, in some embodiments, the network node 200 has obtained a sequence of CSI values reported from the user equipment 160 earlier the CSI report with quality below the quality threshold was received. The precoder bank might then be composed of previously applied, or reported, precoders that correspond to the CSI values as most frequently reported in the sequence of CSI values.

In some aspects, the precoders in the precoder bank are weighted, so that a higher quality CSI report makes a larger impact on which precoder is selected. In particular, in some embodiments, each of the at least two precoders is associated with its own weight factor. The weight factor for each given precoder might then depend on the quality of the CSI report for that precoder, and the weight factors affect how frequently each precoder is cyclically applied.

In some aspects, each reported CSI value is associated with its own set of precoders. In particular, in some embodiments, each CSI value is associated with its own set of at least two precoders. Each of the at least two precoders might then be a function of the at least one CSI value reported from the user equipment 160 earlier than the CSI report with quality below the quality threshold was received. The at least two precoders might be cyclically applied whilst transmitting the data towards the user equipment 160. Further in this respect, a set of precoders, which may or may not belong to a standardized codebook might be associated with each CSI value, and with the quality, or level of uncertainty, of the CSI report. As an example, for low level of uncertainty the set of precoders are taken from a standardized codebook, whereas for a high level of uncertainty there are more precoders in the set of precoders. The set of precoders associated with each CSI value might be hard-coded, or adaptively determined.

In some aspects, historical CSI values are filtered together with the current reported CSI value, which results in a new set of precoders to be cycled through. In particular, in some embodiments, the at least one precoder further is a function of the CSI value in the CSI report with quality below the quality threshold. In one example, the function is defined by moving average filtering of historical precoders together with the precoder corresponding to the currently reported CSI value. In another example, the function defines filter weights that are adjusted based on the quality of the previous CSI reports, in which case a CSI value of a higher quality CSI report makes a larger impact on the filter output.

The at least one precoder might be a function of at least one CSI value reported from the user equipment 160 earlier than the CSI report with quality below the quality threshold was received only for a retransmission of the data. In some aspects, the precoder cycling is thus performed only for retransmissions. In some embodiments, the data is thus transmitted as part of a retransmission of the data. The most likely case is that the reported CSI value corresponds to the correct precoder. However, that a retransmission is needed might indicate that an incorrect precoder was used for the initial transmission of the data and potential earlier retransmissions of the same data. Hence it might be even more beneficial to let the least one precoder be a function of at least one CSI value reported from the user equipment 160 earlier than the CSI report with quality below the quality threshold was received for retransmission of the data compared to initial transmission of the data. Further, in some embodiments, the at least one precoder further is a function of whether the data is transmitted as part of a retransmission of the data or not.

The cycling of the at least two precoders might be performed in the time domain and/or in the frequency domain. In particular, in some embodiments, the data is transmitted in time/frequency resources spanning a time interval and a frequency interval, and the at least two precoders are cyclically applied over the time interval and/or over the frequency interval. Thus, the at least two precoders might be cyclically applied in time (such as every y time slot) or in frequency (such as every z PRB). For example, if the CSI is reported once every 20 time slots, four precoders could be cycled through during this time, with each precoder used in every fourth time slot. In another example, if the bandwidth is 48 PRBs, the four precoders could be cycled across the bandwidth, with each precoder used for 12 PRBs (with the cycling PRB bundle matching the channel estimation PRB bundle). The cycling could also be done in both time and frequency, e.g. where each precoder is used in 24 PRBs every second time slot.

In some aspects, the selection of the cycling bandwidth on which a single precoder has been applied considers the precoding bundling size which has been configure to the reception at the user equipment 160 to guarantee the reliable reception performance. That is, in some embodiments, the frequency interval depends on a precoding bundle size with which the user equipment 160 has been configured.

In some aspects, the quality of the received CSI report is assessed in term of: channel quality indicator (CQI), the quality of the received UCI, reference signal receive power (RSRP) measurements to the serving and neighboring cells and BLER of PDSCH reception. Further information might be taken into account in addition to the quality of the latest CSI report when determining which precoder to use. This may be the content of earlier CSI reports, e.g. if the CQI in earlier CSI reports indicate that the radio propagation channel is good or poor. It may also be the type of transmission, e.g. if it is a retransmission or not. In some non-limiting examples, the at least one precoder thus further is a function of at least one of: channel quality indicator, uplink control information, reference signal receive power measurements as received from the user equipment 160, block error rate of uplink data transmission from the user equipment 160, modulation and coding scheme used by the network node 200 for communicating with the user equipment 160, downlink control information. Previously used precoders might be stored in the precoder bank along with the associated modulation and coding scheme (MCS) or effective code rate and resulting BLER for each individual precoder. Whenever a precoder is to be applied, the BLER and effective code rate or MCS information can be used to determine which previously used precoder is preferred, possibly in different time/frequency allocations. For example, if previously used precoder m is associated with and BLER=0.1 while preciously used precoder n is associated with and BLER=0.2, the network node 200 might allocate previously used precoder m in more time-frequency resources than preciously used precoder n since precoder m has a lower BLER. Similar considerations can also be made with respect to any of MCS, effective code rate, or a combination of such metrics.

In some aspects, any precoders resulting in too high or low effective code rate, MCS, BLER or other metric, might be discarded from the precoder bank. In some embodiments, a precoder corresponding to a CSI value reported in the CSI report with quality below the quality threshold is discarded from is included in a precoder bank comprises candidate precoders for future transmission of data towards the user equipment 160. For example, if previously used precoder k is associated with BLER=0.3, then this precoder might be removed from the precoder bank due to having too high BLER.

In some aspects, which precoder to be used is based on how rapidly the radio propagation channel varies, and thus on estimates of time variability of the radio propagation channel. Therefore, in some embodiments, the network node 200 is configured to perform (optional) step S102:

S102: The network node 200 obtains an estimate of time-wise variability of a radio propagation channel over which the data is transmitted. How long the at least one precoder is to be applied then depends on the estimate.

In this respect, the network node 200 might be configured to estimate the time-wise variability of a radio propagation channel for example by comparing how much channel estimates calculated for different uplink symbols change over time. In some aspects, the network node 200 might be configured to estimate the time-wise variability of a radio propagation channel for example based on earlier received CSI reports. In some aspects, that the CSI report as received from the user equipment 160 served by the network node 200 is of a quality below the quality threshold is determined based on how rapidly the radio propagation channel varies; if the time-wise variability is higher than a threshold variability, the this could give an indication that the CSI report is of low quality.

There could be different ways in which the data is transmitted towards the user equipment 160 in step S106. In some embodiments, the data is transmitted on a physical downlink shared channel (PDSCH).

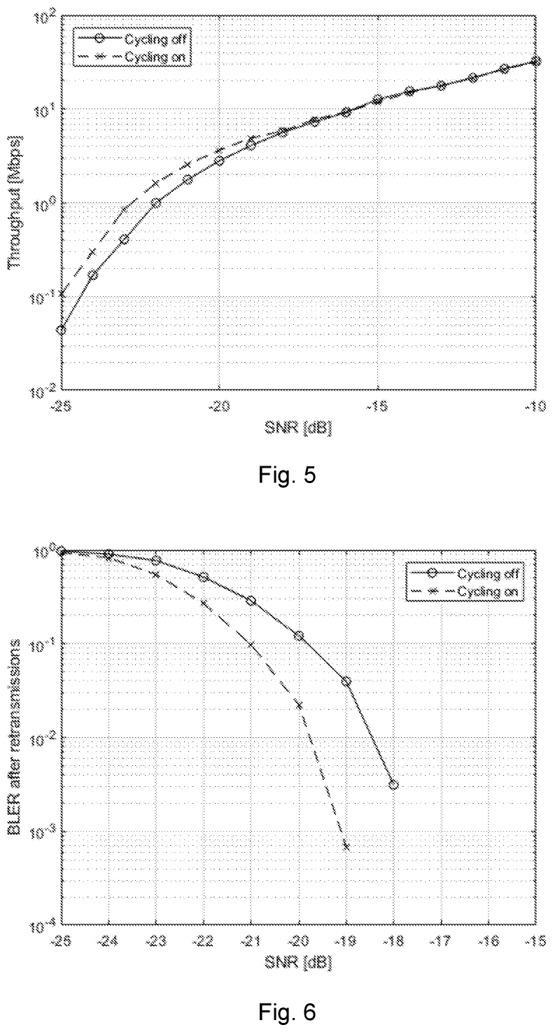

FIG. 5 and FIG. 6 show simulation results according to embodiments. In FIG. 5 is shown throughput in terms of Mbps as a function of SNR. In FIG. 6 is shown BLER after retransmissions (also referred to as residual BLER) as a function of SNR. Both figures compare the performance of using the herein disclosed embodiments with precoder cycling (denoted “cycling on”) to the performance of not using precoder cycling (denoted “cycling off”). The point where the BLER after retransmissions cannot be kept below 1% is often used as the coverage limit, and at that point the SNR gain from cycling precoders is 1.5 dB. For the precoder cycling, the most reported precoders in the last 100 time slots are cycled. 100 time slots correspond to 50 ms, and 5 CSI reports are received during this time. The performance results are shown for a scenario with a TDL-A channel (where TDL is short for tapped-delay-line), medium correlation, 100 ns delay spread, 3.5 GHz carrier frequency, 40 MHz bandwidth, 30 kHz subcarrier spacing, 3 km/h user equipment speed, 32 (transmit) antennas at the TRP 140 and 4 (receive) antennas at the user equipment 160. The downlink reference signal periodicity is 20 time slots (i.e. 10 ms). The maximum number of retransmissions is 3.

In summary, by cycling through earlier used precoders when performing precoded transmission of data to user equipment e.g., in poor coverage or moving at a high speed, issues with using a precoder based on a CSI value of an incorrect CSI report for an extended time is avoided. As it is likely that the user equipment 160 reports the correct CSI value in most cases, and that it is correctly decoded, cycling through previously used precoders is beneficial compared to cycling through random precoders or all possible precoders. This will, for example, mean that different precoders can be used for different retransmissions of data, reducing the risk that all transmissions of the same data fail.

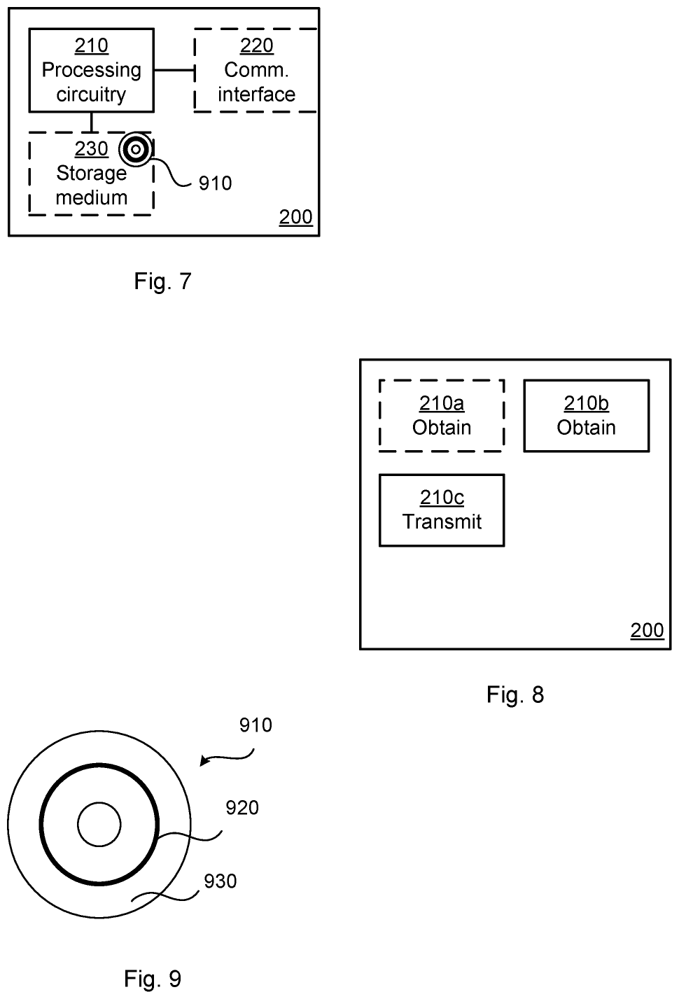

FIG. 7 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, functions, nodes, and devices of the communication network 100. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 8 schematically illustrates, in terms of a number of functional modules, the components of a network node 200 according to an embodiment. The network node 200 of FIG. 8 comprises a number of functional modules; an obtain module 210b configured to perform step S104, and a transmit module 210c configured to perform step S106. The network node 200 of FIG. 8 may further comprise a number of optional functional modules, such as an obtain module 210a configured to perform step S102. In general terms, each functional module 210a:210c may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210c may be implemented by the processing circuitry 210, possibly in cooperation with the communications interface 220 and/or the storage medium 230. The processing circuitry 210 may thus be configured to from the storage medium 230 fetch instructions as provided by a functional module 210a:210c and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 7 the processing circuitry 210 may be distributed among a plurality of devices, or nodes. The same applies to the functional modules 210a:210c of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

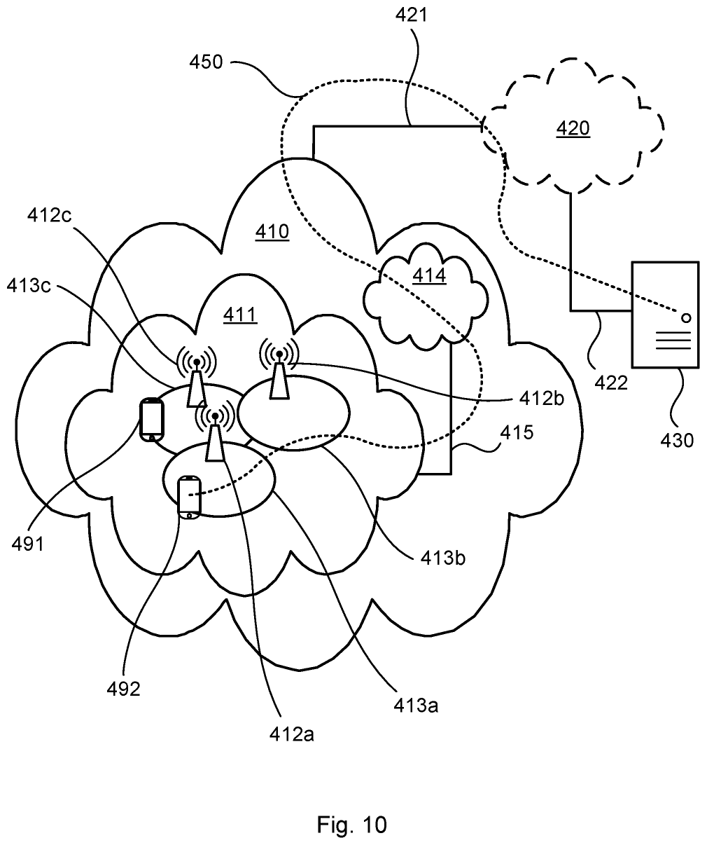

FIG. 10 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 200 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the user equipment 160 of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 10 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

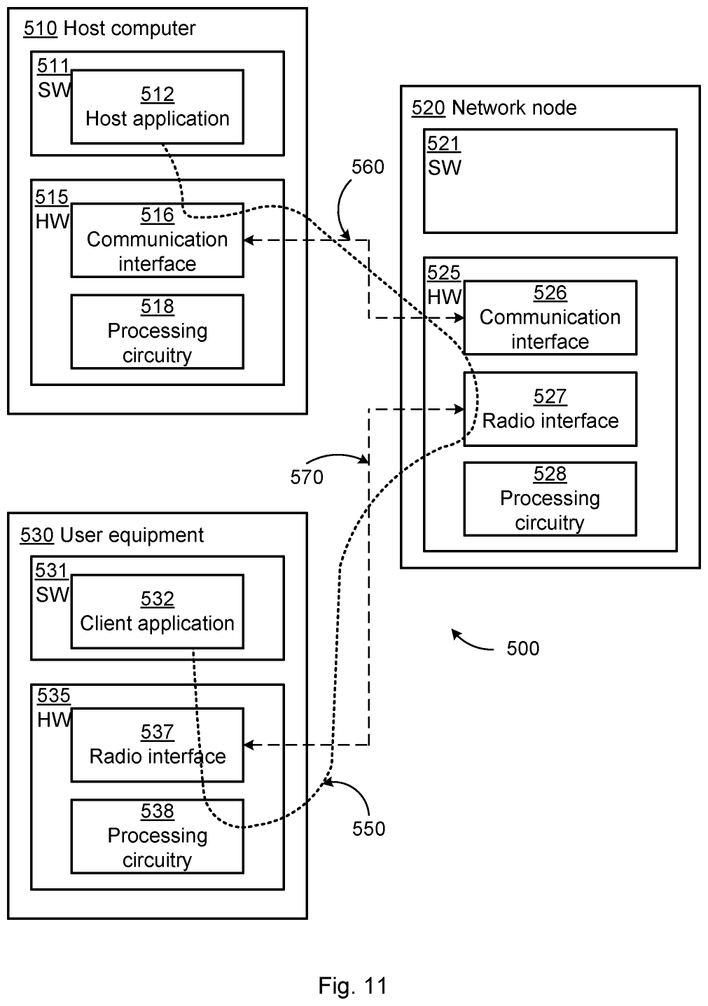

FIG. 11 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 11. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the user equipment 160 of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 200 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 11) served by radio access network node 520. Communication interface 526 may be configured to facilitate connection 560 to host computer 510. Connection 560 may be direct or it may pass through a core network (not shown in FIG. 11) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 11 may be similar or identical to host computer 430, one of network nodes 412a, 412b, 412c and one of UEs 491, 492 of FIG. 10, respectively. This is to say, the inner workings of these entities may be as shown in FIG. 11 and independently, the surrounding network topology may be that of FIG. 10.

In FIG. 11, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signaling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A network node for precoded transmission of data, the network node comprising processing circuitry, the processing circuitry being configured to cause the network node to:
obtain an indication that a channel state information, CSI, report as received from a user equipment served by the network node is of a quality below a quality threshold; and in response thereto:
transmit, whilst applying at least one precoder, data towards the user equipment, wherein the at least one precoder is a function of at least one CSI value reported from the user equipment earlier than the CSI report with quality being below the quality threshold was received.

2. The network node according to claim 1, wherein at least two precoders from a precoder bank are cyclically applied whilst transmitting the data towards the user equipment, and wherein each of the at least two precoders is a function of the at least one CSI value reported from the user equipment earlier than the CSI report with quality being below the quality threshold was received.

3. The network node according to claim 2, wherein the network node has obtained a sequence of CSI values reported from the user equipment earlier than the CSI report with quality being below the quality threshold was received, and wherein the precoder bank is composed of previously applied precoders that correspond to the CSI values as most recently reported in the sequence of reported CSI values.

4. The network node according to claim 3, wherein how many occurrences of each precoder to include in each cycle according to which the at least two precoders from the precoder bank are cyclically applied is a function of frequency of occurrence of the CSI values in the sequence of CSI values.

5. The network node according to claim 2, wherein the network node has obtained a sequence of CSI values reported from the user equipment earlier the CSI report with quality being below the quality threshold was received, and wherein the precoder bank is composed of previously applied precoders that correspond to the CSI values as most frequently reported in the sequence of CSI values.

6. The network node according to claim 2, wherein each of the at least two precoders is associated with its own weight factor, wherein the weight factor for each given precoder depends on the CSI value reported for that precoder, and wherein the weight factors affect how frequently each precoder is cyclically applied.

7. The network node according to claim 1, wherein each CSI value is associated with its own set of at least two precoders, wherein each of the at least two precoders is a function of the at least one CSI value reported from the user equipment earlier than the CSI report with quality being below the quality threshold was received, and wherein the at least two precoders are cyclically applied whilst transmitting the data towards the user equipment.

8. The network node according to claim 1, wherein the at least one precoder further is a function of a CSI value reported in the CSI report with quality being below the quality threshold.

9. The network node according to claim 1, wherein the data is transmitted as part of a retransmission of the data.

10. The network node according to claim 2, wherein the data is transmitted in time/frequency resources spanning a time interval and a frequency interval, and wherein the at least two precoders are cyclically applied over the time interval and/or over the frequency interval.

11. The network node according to claim 10, wherein the frequency interval depends on a precoding bundle size with which the user equipment has been configured.

12. The network node according to claim 1, wherein the at least one precoder further is a function of at least one of: channel quality indicator, uplink control information, reference signal receive power measurements as received from the user equipment, block error rate of uplink data transmission from the user equipment, modulation and coding scheme used by the network node for communicating with the user equipment, downlink control information.

13. The network node according to claim 1, wherein the at least one precoder further is a function of whether the data is transmitted as part of a retransmission of the data or not.

14. The network node according to claim 1, wherein a precoder corresponding to a CSI value reported in the CSI report with quality being below the quality threshold is discarded from being included in a precoder bank comprising candidate precoders for future transmission of data towards the user equipment.

15. The network node according to claim 1, the processing circuitry further being configured to cause the network node to:
obtain an estimate of time-wise variability of a radio propagation channel over which the data is transmitted, and wherein how long the at least one precoder is to be applied depends on the estimate.

16. The network node according to claim 1, wherein the data is transmitted on a physical downlink shared channel, PDSCH.

17. A method for precoded transmission of data, the method being performed by a network node, the method comprising:
obtaining an indication that a channel state information, CSI, report as received from a user equipment served by the network node is of a quality below a quality threshold; and in response thereto:
transmitting, whilst applying at least one precoder, data towards the user equipment, wherein the at least one precoder is a function of at least one CSI value reported from the user equipment earlier than the CSI report with quality being below the quality threshold was received.

18-35. (canceled)

36. A computer readable storage medium comprising instructions which, when executed by a computer, cause the computer to carry out the steps of the method of claim 17.
